(19) United States
(12) Patent Application Publication
(10) Pub. No.: US 2014/0084594 A1
(43) Pub. Date: Mar. 27, 2014

(54) STANDBY GENERATOR INCLUDING TWO AIR-COOLED ENGINES

(71) Applicant: BRIGGS & STRATTON CORPORATION, Wauwatosa, WI (US)

(72) Inventor: Gregory Marchand, Waukesha, WI (US)

(73) Assignee: Briggs & Stratton Corporation, Wauwatosa, WI (US)

(21) Appl. No.: 13/629,036

(22) Filed: Sep. 27, 2012

(51) Int. Cl. H02K 7/18

(52) U.S. Cl. 290/1 A

(57) ABSTRACT

A standby generator includes an alternator, a first air-cooled engine, a second air-cooled engine, and a housing. The alternator includes a stator, a rotor, and an input shaft coupled to the rotor for rotating the rotor. The first air-cooled engine is coupled to the input shaft. The second air-cooled engine is coupled to the input shaft. The housing encloses the alternator, the first air-cooled engine, and the second air-cooled engine.

### BACKGROUND

The present application relates generally to the field of standby generators. Standby generators have become popular as sources of limited amounts of power for short-term use. For example, standby generators are often connected to homes or businesses to provide power in situations where the normal power source (e.g., utility power grid) fails. Standby generators generally include a prime mover that provides mechanical power to a generator or alternator that includes a rotor that rotates to generate electricity. The electricity is delivered via a switch, breaker, or other interruptible device to the home, business, or facility for use. Such generators may be provided in a housing to protect internal components from tampering and the elements and to manage generator noise and exhaust.

### SUMMARY

One embodiment of the invention relates to a standby generator including an alternator, a first air-cooled engine, a second air-cooled engine, and a housing. The alternator includes a stator, a rotor, and an input shaft coupled to the rotor for rotating the rotor. The first air-cooled engine is coupled to the input shaft. The second air-cooled engine is coupled to the input shaft. The housing encloses the alternator, the first air-cooled engine, and the second air-cooled engine.

Another embodiment of the invention relates to a method of operating a standby generator including the steps of operating a first air-cooled engine to drive an alternator and operating a second air-cooled engine to drive the alternator.

Another embodiment of the invention relates to a standby generator including an alternator, a first air-cooled engine, a second air-cooled engine, an electronic governing control, and a housing. The alternator includes a stator, a rotor, two magnetic poles, and an input shaft coupled to the rotor for rotating the rotor at three thousand six hundred rotations per minute. The alternator is rated to provide an output power of forty kilowatts. The first air-cooled engine is coupled to the input shaft to rotate the input shaft. The first air-cooled engine includes two cylinders and is rated to provide an output power of twenty kilowatts. The second air-cooled engine is coupled to the input shaft to rotate the input shaft. The second air-cooled engine includes two cylinders and is rated to provide an output power of twenty kilowatts. The electronic governing control is configured to synchronize the rotational speed of the first air-cooled engine with the rotational speed of the second air-cooled engine. The housing encloses the alternator, the first air-cooled engine, and the second air-cooled engine.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a schematic diagram of a standby generator, shown according to an exemplary embodiment;

FIG. 2 is a schematic diagram of a standby generator, shown according to an exemplary embodiment;

FIG. 2A is a schematic diagram of a standby generator, shown according to an exemplary embodiment;

FIG. 3 is a schematic diagram of a standby generator, shown according to an exemplary embodiment;

FIG. 4 is a schematic diagram of a standby generator, shown according to an exemplary embodiment;

FIG. 5 is a schematic diagram of a standby generator, shown according to an exemplary embodiment;

FIG. 6 is a schematic diagram of a standby generator, shown according to an exemplary embodiment;

FIG. 7 is a schematic diagram of a standby generator, shown according to an exemplary embodiment; and

FIG. 8 is a schematic diagram of a standby generator, shown according to an exemplary embodiment.

The skilled artisan will understand that the drawings primarily are for illustrative purposes and are not intended to limit the scope of the inventive subject matter described herein.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to FIG. 1 a standby generator 100 is shown, according to an exemplary embodiment. The standby generator 100 includes a housing 105, an alternator 110, a first air-cooled engine 115, a second air-cooled engine 120, and electronic governing controller or processing circuit 125. The housing 105 encloses all of the other components of the standby generator 100. Together, the alternator 110 and the two air-cooled engines 115 and 120 may be referred to as an engine-generator set.

The alternator 110 includes a stator 130, a rotor 135, and an input shaft 140 coupled to the rotor 135. The input shaft 140 extends outward from the rotor 135 and includes an attachment portion 145 at or near the end of the input shaft 140. Coupling the attachment portion 145 to a prime mover (e.g., an air-cooled engine) allows the prime mover to rotate the input shaft 140. In use, the input shaft 140 rotates the rotor 135 relative to the stator 130 to create electrical power. The alternator 110 can be a two-pole alternator or a four-pole alternator. To produce the 60 Hz alternating current used in the United States, the rotor of a two-pole alternator must be rotated at 3600 revolutions per minute (“RPM”) and the rotor of a four-pole alternator must be rotated at 1800 RPM. In other embodiments, the alternator 110 produces other frequencies of alternating current. For example, 50 Hz alternating current can be produced with a two-pole alternator rotated at 3000 RPM or with a four-pole alternator rotated at 1500 RPM.

In some embodiments, both engines 115 and 120 are air-cooled two-cylinder internal combustion engines. The first air-cooled engine 115 includes a first cylinder 150, a second cylinder 155, a driveshaft 160, an air-fuel mixing device (not shown), such as a carburetor, and an air cleaner (not shown) positioned to filter particulate matter from an air stream before the air is directed to the air-fuel mixing device. In other embodiments, the engines may employ other fuel mixing devices such as fuel injection. The cylinders 150 and 155 operate to rotate the driveshaft 160. The driveshaft 160 includes an end portion or power take off (PTO) 165 configured to be coupled to an object to be rotated. The second air-cooled engine 120 includes a first cylinder 170, a second cylinder 175, a driveshaft 180 having a PTO 185, an air-fuel mixing device (not shown), and an air cleaner (not shown) as described above with respect to the first air-cooled engine 115.

In one embodiment, each of the air-cooled engines 115 and 120 has a displacement of less than one liter and is rated at an output power of twenty kilowatts (20 kW). This results in a standby generator 100 rated at an output power of forty kilowatts (40 kW). The fuel used to power the air-cooled engines 115 and 120 is preferably natural gas or propane; however, other combustible fuels (e.g., fuel oil, gasoline) may be used. The rated output of the air-cooled engine 115 or 120 will vary based on the type of fuel used. The pair of air-cooled engines 115 and 120 may consist of two horizontal shaft air-cooled engines, two vertical shaft air-cooled engines, or one horizontal shaft air-cooled engine and one vertical shaft air-cooled engine. In other embodiments, other air-cooled engines having a different displacement and/or different power output ratings are used, resulting in different output power ratings for the associated standby generator.

The PTO 165 of the first air-cooled engine 115 is indirectly coupled to the attachment portion 145 of the input shaft 140 of the alternator 110 by a transmission 190. The PTO 185 of the second air-cooled engine 120 is also indirectly coupled to the attachment portion 145 of the input shaft 140 by a transmission 195. The transmissions 190 and 195 can be belt drives, chain drives, gear drives, or other type of transmissions. Indirect coupling allows for a reduction between the engine and the alternator. In this way, the engine 115 can be driven at a speed less than the synchronous speed of the alternator 110 with the transmission 190 providing the gear ratio necessary to rotate the alternator 110 at the synchronous speed (e.g., 1800 RPM or 3600 RPM) given a predetermined engine operating speed. The transmission 190 allows the engine operating speed to be reduced relative to a standby generator in which the transmission is not included, thereby reducing the noise produced when the engine 115 is running.

In use, each air-cooled engine 115 and 120 is operated to rotate its respective driveshaft 160 or 180, which in turn rotates the input shaft 140 of the alternator 110 via the respective transmission 190 or 195, thereby rotating the rotor 135 and generating electricity. The two air-cooled engines 115 and 120 drive the alternator 110 in parallel. The electronic governing controller 125 communicates with both air-cooled engines 115 and 120 to synchronize the rotational speed of the driveshaft 160 of the first air-cooled engine 115 with the rotational speed of the driveshaft 180 of the second air-cooled engine 120 such that the input shaft 140 is driven at a constant rotational speed. The controller or processing circuit 125 can include a processor and memory device. Processor can be implemented as a general purpose processor, an application specific integrated circuit (ASIC), one or more field programmable gate arrays (FPGAs), a group of processing components, or other suitable electronic processing components. Memory device (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. Memory device may be or include volatile memory or non-volatile memory. Memory device may include database components, object code components, script components, or any other type of information structure for supporting the various activities and information structures described in the present application. According to an exemplary embodiment, memory device is communicably connected to processor via processing circuit and includes computer code for executing (e.g., by processing circuit and/or processor) one or more processes described herein. As illustrated, the electronic governing controller 125 is a single controller in communication with both air-cooled engines 115 and 120. In some embodiments, the electronic governing controller 125 includes a controller associated with each air-cooled engine 115 and 120 and the two controllers communicate with one another.

The standby generator 100 replaces the single engine used in known standby generators with two engines 115 and 120. For example, known standby generators rated at an output power of 40 kW and above use a single large (e.g., eight cylinder) liquid-cooled engine. A liquid-cooled engine requires liquid coolant, a radiator, and the plumbing necessary for routing the liquid coolant between the engine and the radiator. These additional components add cost, complexity, and physical size to the liquid-cooled engine when compared to an air-cooled engine. By using two smaller (e.g., two cylinder) air-cooled engines in place of the single larger engine, the standby generator 100 can achieve a rating of 40 kW and above while being smaller in physical size and potentially costing less to produce than a similar standby generator rated at 40 kW or above that is equipped with a single, larger (e.g., eight cylinder) liquid-cooled engine. Also, a standby generator 100 equipped with two smaller engines can result in reduced operating noise when compared to a similarly rated standby generator equipped with a single larger engine. One way this is possible is by using a four-pole alternator and running the two engines at 1800 RPM, which produces less noise than a similarly rated standby generator using a two-pole alternator and running a single larger engine at 3600 RPM.

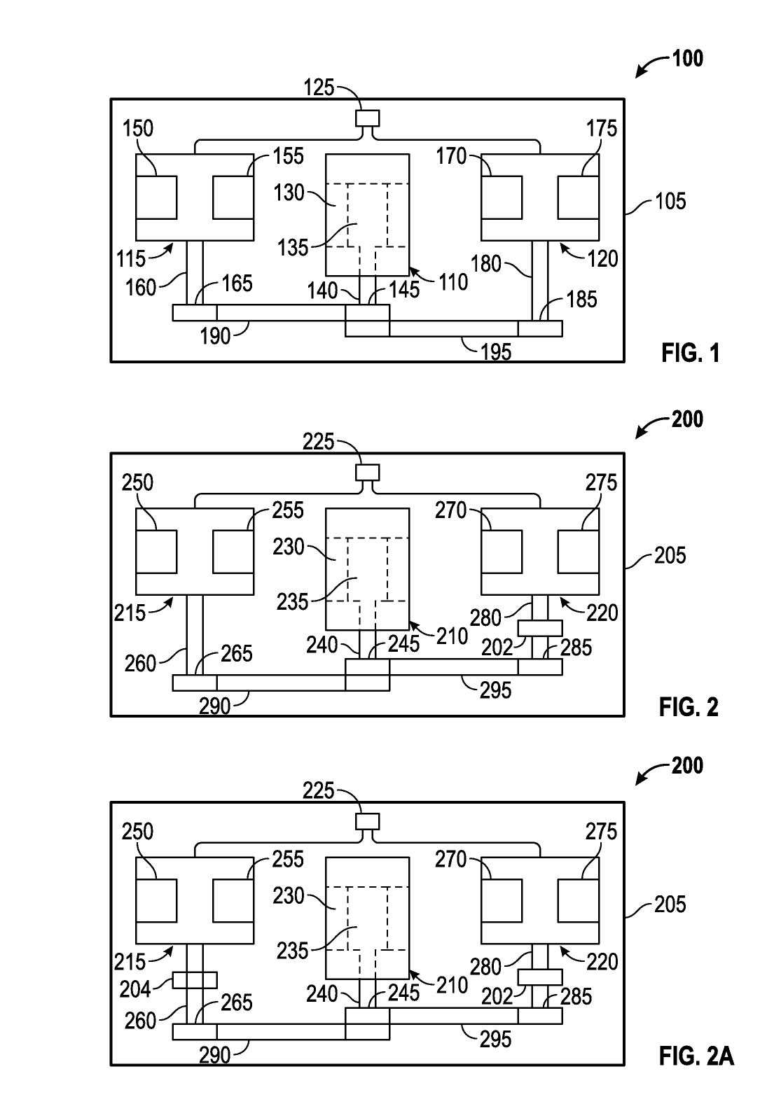

FIGS. 2-8 illustrate additional embodiments of a standby generator. Components similar to those described with respect to the standby generator 100 are described with the same name and with the same last two digits of the reference number.

Referring to FIG. 2, a standby generator 200 is shown, according to an exemplary embodiment. The standby generator 200 includes the same components as the standby generator 100 and a clutch 202. The clutch 202 is configured to selectively engage and disengage the second air-cooled engine 220 with the input shaft 240 of the alternator 210 such that the rotational energy of the second air-cooled engine 220 is transferred to the input shaft 240 when the clutch 202 is engaged and the rotational energy of the second air-cooled engine 220 is not transferred to the input shaft 240 when the clutch 202 is disengaged. As illustrated, the clutch 202 is coupled between a first portion and a second portion of the driveshaft 280. In other embodiments, the clutch 202 is a component of the transmission 295 or coupled to any appropriate portion of the drivetrain between the second air-cooled engine 220 and the input shaft 240. The addition of the clutch 202 allows the generator 200 to run in two modes: a low load mode using only the first air-cooled engine 215 and a high load mode using both the first air-cooled engine 215 and the second air-cooled engine 220. The fuel efficiency of the standby generator 200 is improved by using the second air-cooled engine 220 only when needed as determined by the load on the standby generator 200. Also, the low load mode produces less noise than the high load mode. In some embodiments, the clutch 202 is an overrunning clutch.

Referring to FIG. 2A, standby generator 200 is shown with a second clutch 204. The second clutch 204 is similar to the clutch 202 as described above and is configured to selectively engage and disengage the first air-cooled engine 215 with the input shaft 240 of the alternator 210 such that the rotational energy of the first air-cooled engine 215 is transferred to the input shaft 240 when the clutch 204 is engaged and the rotational energy of the first air-cooled engine 215 is not transferred to the input shaft 240 when the clutch 204 is disengaged. By providing a clutch 202 and 204 with each air-cooled engine 215 and 220, respectively, the standby generator 200 can be operated by either or both of the air-cooled engines 215 and 220. In this way, a single air-cooled engine 215 or 220 can be operated until the load demand requires the second air cooled engine 215 or 220 to be engaged by its associated clutch 202 or 204. Also, if either of the air-cooled engines 215 or 220 experiences a problem or malfunction that prevents it from functioning, the standby generator 200 can still be operated using the remaining functional air-cooled engine 215 or 220. This provides redundancy that helps to ensure that the standby generator 200 will always be able to provide some power when called upon to do so.

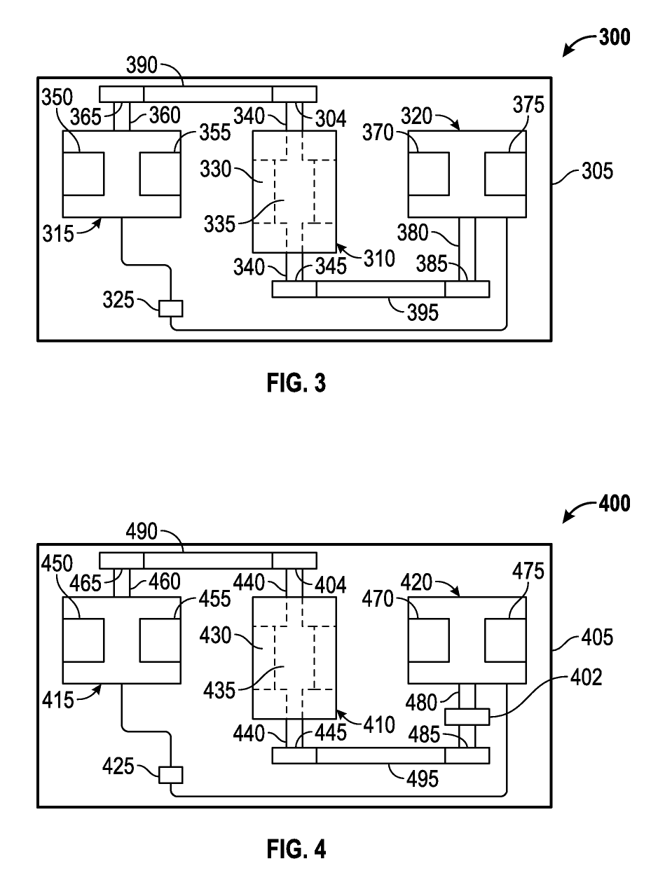

Referring to FIG. 3, a standby generator 300 is shown, according to an exemplary embodiment. The standby generator 300 includes many of the same components as the standby generator 100 and a double shaft alternator 310 having a second attachment portion 304 on the input shaft 340. The input shaft 340 extends past two opposite ends of the rotor 335 with the first attachment portion 345 located at or near a first end of the input shaft 340 and the second attachment portion 304 located at or near the opposite end of the input shaft 340. This type of alternator is known as a double-shaft alternator. The second attachment portion 304 is located opposite the first attachment portion 345. The PTO 365 of the first air-cooled engine 315 is indirectly coupled to the second attachment portion 304 by the transmission 390. In some embodiments, the input shaft 340 is two separate shafts such that one shaft extends past either end of the rotor 335.

Referring to FIG. 4, a standby generator 400 is shown, according to an exemplary embodiment. The standby generator 400 includes the same components as the standby generator 300 and a clutch 402 similar to the clutch 202 of the standby generator 200. The clutch 402 is configured to selectively engage and disengage the second air-cooled engine 420 with the input shaft 440 of the alternator 410 in a manner similar to the clutch 202

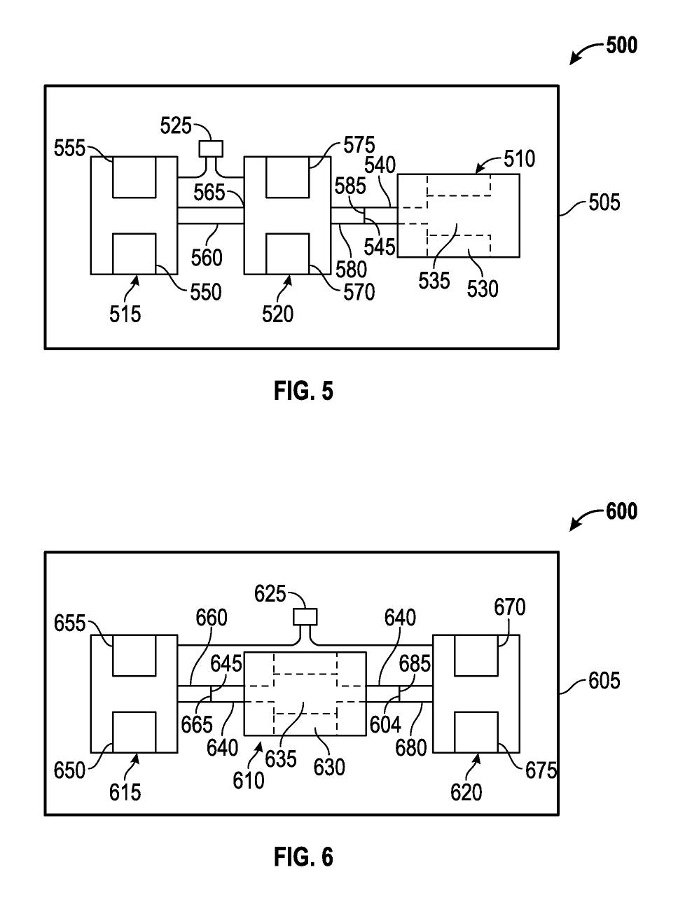

Referring to FIG. 5, a standby generator 500 is shown, according to an exemplary embodiment. The standby generator 500 includes many of the same components as the standby generator 100. The two-air-cooled engines 515 and 520 are directly coupled to the alternator 510 in a direct drive arrangement, rather than indirectly coupled to the alternator with transmissions like the standby generator 100. In a direct drive arrangement, there is no reduction between the engine and the alternator. The PTO 565 of the first air-cooled engine 515 is directly coupled to the driveshaft 580 of the second air-cooled engine 520. The PTO 585 of the second air-cooled engine 520 is directly coupled to the attachment portion 545 of the input shaft 540 of the alternator 510. The two air-cooled engines 515 and 520 drive the alternator 510 in series. In some embodiments, a clutch configured to selectively engage and disengage the first air-cooled engine 515 with the driveshaft 580 of the second air-cooled engine 520 is included. This clutch is similar to the clutch 202 described with respect to standby generator 200 and allows the standby generator 500 to run in either a low load mode or a high load mode.

Referring to FIG. 6, a standby generator 600 is shown, according to an exemplary embodiment. The standby generator 600 includes many of the same components as the standby generator 300. The two-air-cooled engines 615 and 620 are directly coupled to the double-shaft alternator 610 in a direct drive arrangement, rather than indirectly coupled to the alternator with transmissions like the standby generator 300. The PTO 665 of the first air-cooled engine 615 is directly coupled to the first attachment portion 645 of the input shaft 640 of the alternator 610 in a direct drive arrangement. The PTO 685 of the second air-cooled engine 620 is directly coupled to the second attachment portion 604 of the input shaft 640 in a direct drive arrangement. In some embodiments, a clutch configured to selectively engage and disengage the second air-cooled engine 820 with the input shaft 840 of the alternator 810 is included. This clutch is similar to the clutch 202 described with respect to standby generator 200 and allows the standby generator 500 to run in either a low load mode or a high load mode.

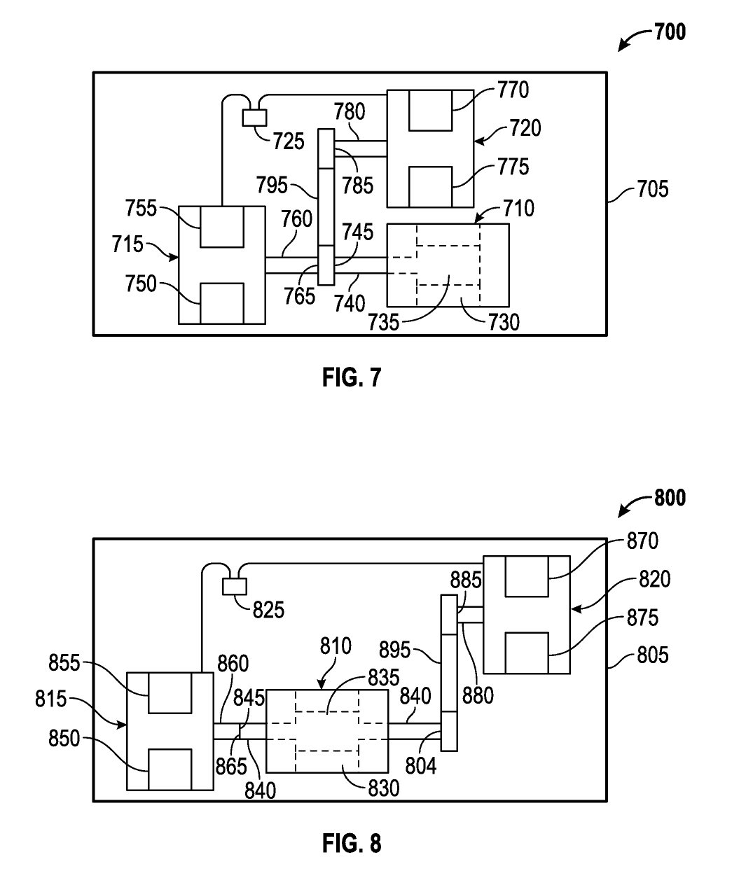

Referring to FIG. 7, a standby generator 700 is shown, according to an exemplary embodiment. The standby generator 700 includes many of the same components of the standby generator 100. The PTO 765 of the first air-cooled engine 715 is directly coupled to the attachment portion 745 of the input shaft 740 of the alternator 710 and the PTO 785 of the second air-cooled engine 720 is indirectly coupled to the attachment portion 745 of the input shaft 740 of the alternator 710 by the transmission 795. In some embodiments, a clutch configured to selectively engage and disengage the second air-cooled engine 720 with the input shaft 740 of the alternator 710 is included. This clutch is similar to the clutch 202 described with respect to standby generator 200.

Referring to FIG. 8, a standby generator 800 is shown, according to an exemplary embodiment. The standby generator 800 is similar to the standby generator 300. The first air-cooled engine 815 is directly coupled to the double-shaft alternator 810 and the second air-cooled engine 820 is indirectly coupled to the double-shaft alternator 810 by the transmission 895. The PTO 865 of the first air-cooled engine 815 is directly coupled to the first attachment portion 845 of the input shaft 840 of the alternator 810 in a direct drive arrangement. The PTO 885 of the second air-cooled engine 820 is indirectly coupled to the second attachment portion 804 of the input shaft 840 of the alternator 810 by the transmission 895. In some embodiments, a clutch configured to selectively engage and disengage the second air-cooled engine 820 with the input shaft 840 of the alternator 810 is included. This clutch is similar to the clutch 202 described with respect to standby generator 200.

The construction and arrangements of the standby generator, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show or the description may provide a specific order of method steps, the order of the steps may differ from what is depicted. Also two or more steps may be performed concurrently or with partial concurrence. Such variation will depend on various factors, including software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A standby generator, comprising:
an alternator including a stator, a rotor, and an input shaft coupled to the rotor for rotating the rotor;
a first air-cooled engine coupled to the input shaft;
a second air-cooled engine coupled to the input shaft; and
a housing enclosing the alternator, the first air-cooled engine, and the second air-cooled engine.

2. The standby generator of claim 1, wherein the first air-cooled engine is directly coupled to the input shaft; and
wherein the second air-cooled engine is directly coupled to the input shaft.

3. The standby generator of claim 1, further comprising:
a first transmission indirectly coupling the first air-cooled engine to the input shaft; and
a second transmission indirectly coupling the second air-cooled engine to the input shaft.

4. The standby generator of claim 1, further comprising:
a transmission indirectly coupling the second air-cooled engine to the input shaft; and
wherein the first air-cooled engine is directly coupled to the input shaft.

5. The standby generator of claim 1, further comprising:
a first clutch configured to selectively engage and disengage the first air-cooled engine with the input shaft such that the rotational energy of the first air-cooled engine is transferred to the input shaft when the first clutch is engaged and the rotational energy of the first air-cooled engine is not transferred to the input shaft when the first clutch is disengaged.

6. The standby generator of claim 5, further comprising:
a second clutch configured to selectively engage and disengage the second air-cooled engine with the input shaft such that the rotational energy of the second air-cooled engine is transferred to the input shaft when the second clutch is engaged and the rotational energy of the second air-cooled engine is not transferred to the input shaft when the second clutch is disengaged.

7. The standby generator of claim 1, wherein the input shaft includes a first attachment portion and a second attachment portion opposite the first attachment portion;
wherein the first air-cooled engine is coupled to the first attachment portion of the input shaft; and
wherein the second air-cooled engine is coupled to the second attachment portion of the input shaft.

8. The standby generator of claim 7, wherein the first air-cooled engine is directly coupled to the first attachment portion of the input shaft; and
wherein the second air-cooled engine is directly coupled to the second attachment portion of the input shaft.

9. The standby generator of claim 7, further comprising:
a first transmission indirectly coupling the first air-cooled engine to the first attachment portion of the input shaft; and
a second transmission indirectly coupling the second air-cooled engine to the second attachment portion of the input shaft.

10. The standby generator of claim 7, further comprising:
a transmission indirectly coupling the second air-cooled engine to the second attachment portion of the input shaft; and
wherein the first air-cooled engine is directly coupled to the first attachment portion of the input shaft.

11. The standby generator of claim 7, further comprising:
a first clutch configured to selectively engage and disengage the first air-cooled engine with the input shaft such that the rotational energy of the first air-cooled engine is transferred to the input shaft when the first clutch is engaged and the rotational energy of the first air-cooled engine is not transferred to the input shaft when the first clutch is disengaged.

12. The standby generator of claim 7, further comprising:
a second clutch configured to selectively engage and disengage the second air-cooled engine with the input shaft such that the rotational energy of the second air-cooled engine is transferred to the input shaft when the second clutch is engaged and the rotational energy of the second air-cooled engine is not transferred to the input shaft when the second clutch is disengaged.

13. The standby generator of claim 1, further comprising:
an electronic governing controller configured to synchronize the rotational speed of the first air-cooled engine with the rotational speed of the second air-cooled engine.

14. A method of operating a standby generator comprising:
operating a first air-cooled engine to drive an alternator; and
operating a second air-cooled engine to drive the alternator.

15. The method of claim 14, further comprising:
directly coupling the first air-cooled engine to an input shaft of the alternator; and
directly coupling the second air-cooled engine to the input shaft of the alternator.

16. The method of claim 14, further comprising:
indirectly coupling the first air-cooled engine to an input shaft of the alternator; and
indirectly coupling the second air-cooled engine to the input shaft of the alternator.

17. The method of claim 14, further comprising:
directly coupling the first air-cooled engine to an input shaft of the alternator; and
indirectly coupling the second air-cooled engine to the input shaft of the alternator.

18. The method of claim 14, further comprising:
selectively engaging a first clutch such that the rotational energy of the first air-cooled engine is transferred to an input shaft of the alternator when the first clutch is engaged;
selectively disengaging the first clutch such that the rotational energy of the first air-cooled engine is not transferred to the input shaft when the first clutch is disengaged.

19. The method of claim 18, further comprising:
selectively engaging a second clutch such that the rotational energy of the second air-cooled engine is transferred to an input shaft of the alternator when the second clutch is engaged;
selectively disengaging the second clutch such that the rotational energy of the second air-cooled engine is not transferred to the input shaft when the second clutch is disengaged.

20. A standby generator comprising:
an alternator including a stator, a rotor, two magnetic poles, and an input shaft coupled to the rotor for rotating the rotor at three thousand six hundred rotations per minute, the alternator rated to provide an output power of forty kilowatts;
a first air-cooled engine coupled to the input shaft to rotate the input shaft, the first air-cooled engine including two cylinders and rated to provide an output power of twenty kilowatts;
a second air-cooled engine coupled to the input shaft to rotate the input shaft, the second air-cooled engine including two cylinders and rated to provide an output power of twenty kilowatts;
an electronic governing control configured to synchronize the rotational speed of the first air-cooled engine with the rotational speed of the second air-cooled engine; and
a housing enclosing the alternator, the first air-cooled engine, and the second air-cooled engine.
